(19) United States
(12) Patent Application Publication
(10) Pub. No.: US 2025/0194680 A1
(43) Pub. Date: Jun. 19, 2025

(54) HEATING ASSEMBLY AND AEROSOL-GENERATING APPARATUS COMPRISING THE HEATING ASSEMBLY

(71) Applicant: SHENZHEN FIRST UNION TECHNOLOGY CO., LTD., Shenzhen, Guangdong (CN)

(72) Inventors: Zhiming LU, Shenzhen, Guangdong (CN); Zhongli XU, Shenzhen, Guangdong (CN); Yonghai LI, Shenzhen, Guangdong (CN)

(73) Assignee: SHENZHEN FIRST UNION TECHNOLOGY CO., LTD., Shenzhen, Guangdong (CN)

(21) Appl. No.: 18/843,478

(22) PCT Filed: Feb. 15, 2023
(86) PCT No.: PCT/CN2023/076220

§ 371 Date: Sep. 3, 2024

(30) Foreign Application Priority Data
Mar. 4, 2022 (CN) 202220473179.2

(51) Int. Cl. A24F 40/46; H05B 3/03

(52) U.S. Cl. CPC A24F 40/46; H05B 3/03

(57) ABSTRACT

A heating assembly and an aerosol-generating apparatus are provided. The heating assembly includes a heater and an electrode connecting member. The heater heats an aerosol-forming substrate to generate an aerosol. The heater is provided with an electrode. The electrode connecting member includes a first contact piece and a second contact piece. At least one of the first contact piece and the second contact piece maintains contact with the electrode to form an electrical connection. The first contact piece is provided with a first connecting portion, and the second contact piece is provided with a second connecting portion that is separated from the first connecting portion. The first connecting portion and the second connecting portion may be integrated together to hold the electrode connecting member on the heater.

### CROSS-REFERENCE TO RELATED APPLICATIONS

This application claims priority to Chinese Patent Application No. 202220473179.2, filed with the China National Intellectual Property Administration on Mar. 4, 2022 and entitled “HEATING ASSEMBLY AND AEROSOL-GENERATING APPARATUS INCLUDING THE HEATING ASSEMBLY”, which is incorporated herein by reference in its entirety.

### TECHNICAL FIELD

This application relates to the field of electronic atomization technologies, and in particular, to a heating assembly and an aerosol-generating apparatus including the heating assembly.

### BACKGROUND

In an existing aerosol-generating apparatus, a far infrared electric heating coating and a conductive coating are applied on outside of a tubular base body, and the far infrared electric heating coating, after being energized, emits far infrared rays that penetrate the base body to heat an aerosol-forming substrate inside the base body.

In the aerosol-generating apparatus, a C-shaped electrode contact piece with an opening (as shown in FIG. 1) is usually used. An inner diameter of the electrode contact piece is slightly less than an outer diameter of the tubular base body. During mounting, the opening of the electrode contact piece is first opened, then the electrode contact piece is inserted into the tubular base body in an axial direction, and then the electrode contact piece is released, so that an inner wall of the electrode contact piece maintains contact with the conductive coating, thereby forming an electrical connection.

During fitting, the existing C-shaped electrode contact piece is inconvenient to operate, which results in low efficiency. After the fitting, the electrode contact piece is likely to move as a result of not being fixed, which affects the electrical connection between the electrode contact piece and the conductive coating.

### SUMMARY

An aspect of this application provides a heating assembly, including:
a heater, configured to heat an aerosol-forming substrate to generate an aerosol, where the heater is provided with an electrode; and
an electrode connecting member, including a first contact piece and a second contact piece, where at least one of the first contact piece and the second contact piece maintains contact with the electrode to form an electrical connection.

The first contact piece is provided with a first connecting portion, the second contact piece is provided with a second connecting portion that is separated from the first connecting portion, and the first connecting portion and the second connecting portion are configured to be integrated together to hold the electrode connecting member on the heater.

Another aspect of this application provides an aerosol-generating apparatus, including a power supply assembly and the heating assembly.

According to the heating assembly and the aerosol-generating apparatus including the heating assembly provided in this application, through the mating between the first connecting portion of the first contact piece and the second connecting portion of the second contact piece, the electrode connecting member is held on the heater, such that movement is unlikely to occur between the electrode connecting member and the heater, thereby ensuring the electrical connection between the electrode connecting member and the heater.

### BRIEF DESCRIPTION OF THE DRAWINGS

One or more embodiments are exemplarily described with reference to corresponding figures in drawings, and the exemplary descriptions are not to be construed as a limitation on the embodiments. Elements in the drawings having same reference numerals represent similar elements. Unless otherwise particularly stated, the figures in the drawings are not drawn to scale.

FIG. 1 is a schematic diagram of an existing electrode contact piece.

FIG. 2 is a schematic diagram of an aerosol-generating apparatus according to an implementation of this application.

FIG. 3 is a schematic diagram of an aerosol-generating apparatus and an aerosol-generating article according to an implementation of this application.

FIG. 4 is a schematic diagram of a heater according to an implementation of this application.

FIG. 5 is a schematic diagram of another heater according to an implementation of this application.

FIG. 6 is a schematic diagram of another heater according to an implementation of this application.

FIG. 7 is a schematic diagram of another heater according to an implementation of this application.

FIG. 8 is a schematic diagram of still another heater according to an implementation of this application.

FIG. 9 is a schematic diagram of a heating assembly according to an implementation of this application.

FIG. 10 is a schematic sectional view of a heating assembly according to an implementation of this application.

FIG. 11 is a schematic diagram of a heater, an electrode connecting member, and a fixing member after fitting according to an implementation of this application.

FIG. 12 is a schematic diagram of an electrode connecting member according to an implementation of this application.

FIG. 13 is a schematic diagram of a fixing member according to an implementation of this application.

FIG. 14 is a schematic diagram of an upper end cap according to an implementation of this application.

FIG. 15 is a schematic diagram of a lower end cap according to an implementation of this application.

### DETAILED DESCRIPTION

For ease of understanding of this application, this application is described below in more detail with reference to drawings and specific implementations. It should be noted that, when an element is expressed as “being fixed to” another element, the element may be directly on the another element, or one or more intermediate elements may exist between the element and the another element. When an element is expressed as “being connected to” another element, the element may be directly connected to the another element, or one or more intermediate elements may exist between the element and the another element. Terms “upper”, “lower”, “left”, “right”, “inner”, “outer”, and similar expressions used in this specification are merely used for illustration.

Unless otherwise defined, meanings of all technical and scientific terms used in this specification are the same as those usually understood by a person skilled in the art. Terms used in this specification of this application are merely intended to describe objectives of the specific implementations, and are not intended to limit this application. A term “and/or” used in this specification includes any or all combinations of one or more related listed items.

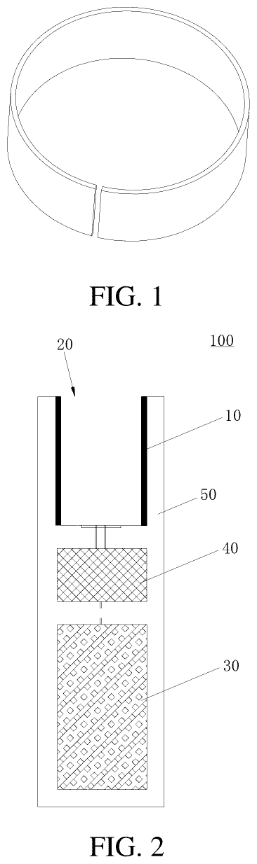

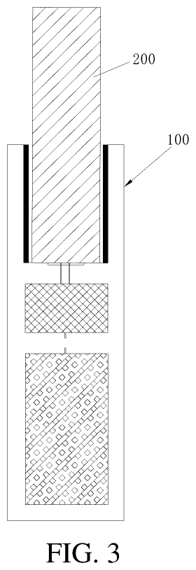

FIG. 1 to FIG. 2 show an aerosol-generating apparatus 100 according to an implementation of this application. The apparatus includes a heater 10, a chamber 20, cell 30, a circuit 40, and a housing 50. The heater 10, the chamber 20, the cell 30, and the circuit 40 are all arranged in the housing 50.

The heater 10 is configured to radiate infrared rays to heat an aerosol-forming substrate.

The chamber 20 is configured to receive the aerosol-forming substrate.

The aerosol-forming substrate is a substrate that can release a volatile compound that can form an aerosol. The volatile compound may be released by heating the aerosol-forming substrate. The aerosol-forming substrate may be a solid or a liquid, or may include solid and liquid components. The aerosol-forming substrate may be loaded onto a carrier or a support through adsorption, coating, or impregnation, or in another manner. The aerosol-forming substrate is a part of an aerosol-generating article 200.

The aerosol-forming substrate may include nicotine. The aerosol-forming substrate may include tobaccos, for example, may include a tobacco-containing material including volatile compounds with a tobacco aroma. The volatile compounds with a tobacco aroma are released from the aerosol-forming substrate when the aerosol-forming substrate is heated. The aerosol-forming substrate may include at least one aerosol-forming agent. The aerosol-forming agent may be any suitable known compound or a mixture of compounds. During use, the compound or the mixture of compounds facilitates dense and stable aerosol formation, and is substantially resistant to thermal degradation at an operating temperature of an aerosol-generating system. Suitable aerosol-forming agents are well known in the related art, including but not limited to: polyol, such as triethylene glycol, 1,3-butanediol, and glycerol; a polyol ester, such as glycerol acetate, glycerol diacetate, or glycerol triacetate; and a fatty acid ester of a monocarboxylic acid, a dicarboxylic acid, or a polycarboxylic acid, such as dimethyl dodecanedioate and dimethyl tetradecanedioate. Preferably, the aerosol-forming agent is polyhydric alcohol or a mixture thereof, such as triethylene glycol, or 1,3-butanediol, and most preferably, glycerol.

The cell 30 supplies power for operating the aerosol-generating apparatus 100. For example, the cell 30 may supply power to heat the heater 10. In addition, the cell 30 may supply power for operating other elements provided in the aerosol-generating apparatus 100. The cell 30 may be a rechargeable battery or a disposable battery.

The circuit 40 may control overall operations on the aerosol-generating apparatus 100. The circuit 40 not only controls operations on the cell 30 and the heater 10, but also controls operations on other elements in the aerosol-generating apparatus 100. For example, the circuit 40 obtains temperature information of the heater 10 sensed by a temperature sensor, and controls, based on the information, the power supplied by the cell 30 to the heater 10.

It should be noted that, in another example, the heater 10 may include a heater adopting resistive heating. For example, a heater of a heating circuit is manufactured by printing metal tungsten or molybdenum manganese paste.

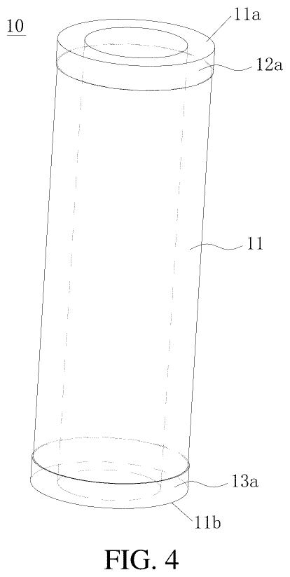

FIG. 4 shows a heater 10 according to an example of this application. The heater includes a base body 11 and a conductive element.

The base body 11 includes a first end 11a and a second end 11b and a surface extending between the first end 11a and the second end 11b. Inside of the base body 11 is hollow to form at least part of the chamber 20. The base body 11 may be in a shape of a cylinder or a prism, or another column shape. As an example rather than a limitation, the base body 11 is optionally in the shape of a cylinder, and a cylindrical hole extending through a middle part of the base body 11 forms at least part of the chamber 20. An inner diameter of the hole is slightly greater than an outer diameter of an aerosol-generating article 200, so that the aerosol-generating article 200 can be inserted into the chamber 20 for heating.

Exemplarily, the base body 11 may be made of a material that is high temperature-resistant and transparent, such as quartz glass, ceramic, or mica, or may be made of other materials having a high infrared transmittance, for example, a high temperature-resistant material having an infrared transmittance of at least 95%. The material of the base body 11 is not limited herein.

An infrared electric heating coating may be formed on an outer surface of the base body 11. The infrared electric heating coating generates heat under an action of power, to generate an infrared ray with a specific wavelength, for example, a far infrared ray of 8 μm to 15 μm. The wavelength of the infrared ray is not limited. The infrared ray may be an infrared ray of 0.75 μm to 1000 μm, or preferably, an infrared ray of 1.5 μm to 400 μm.

The conductive element includes a first electrode 12a and a second electrode 13a spaced apart on the base body 11, which are configured to feed the power supplied by the cell 30 to the infrared electric heating coating.

The first electrode 12a and the second electrode 13a are both in an annular shape, i.e., arranged in a circumferential direction of the base body 11. Axial lengths of the first electrode 12a and the second electrode 13a are approximately 2 mm. The first electrode 12a and the second electrode 13a both maintain contact with the infrared electric heating coating to form an electrical connection. The first electrode 12a may be arranged on the infrared electric heating coating. Alternatively, a part of the first electrode 12a is arranged on the infrared electric heating coating, and another part of the first electrode 12a is arranged on the outer surface of the base body 11. Alternatively, a part of the first electrode 12a is arranged between the infrared electric heating coating and the outer surface of the base body 11, and another part of the first electrode 12a is arranged on the outer surface of the base body 11. The second electrode 13a is arranged similarly. After the first electrode 12a and the second electrode 13a are energized, a current can flow axially from one of the electrodes to the other of the electrodes through the infrared electric heating coating.

The first electrode 12a and the second electrode 13a are both conductive coatings, which may be metal coatings, conductive tapes, or the like. The metal coatings may be made of silver, gold, palladium, platinum, copper, nickel, molybdenum, tungsten, niobium, or an alloy material of the metals.

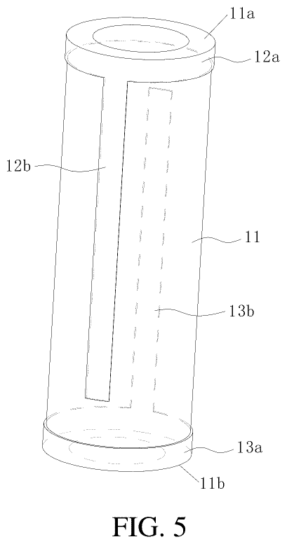

FIG. 5 shows another heater 10 according to an example of this application. The heater differs from the heater shown in FIG. 4 in that the conductive element further includes a conductive portion 12b extending axially from the first electrode 12a toward the second electrode 13a and a conductive portion 13b extending axially from the second electrode 13a toward the first electrode 12a. The conductive portion 12b and the conductive portion 13b both maintain contact with the infrared electric heating coating to form an electrical connection. The conductive portion 12b and the conductive portion 13b separate the infrared electric heating coating into two infrared electric heating coatings in a circumferential direction. In this way, after the first electrode 12a and the second electrode 13a are energized, a current can flow circumferentially from one of the conductive portions to the other of the conductive portions through the two infrared electric heating coatings.

In the example of FIG. 5, the first electrode 12a and the second electrode 13a may not be in contact with the infrared electric heating coating, i.e., the first electrode 12a and the second electrode 13a may be spaced apart from the infrared electric heating coating.

Unlike the example in FIG. 5, in another example, the conductive element may include a plurality of conductive portions 12b and a plurality of conductive portions 13b. The plurality of conductive portions 12b and the plurality of conductive portions 13b can separate the infrared electric heating coating into a plurality of infrared electric heating coatings in the circumferential direction.

Unlike the example in FIG. 5, in another example, the conductive portion 12b and the conductive portion 13b may not extend axially, for example, may extend in a zigzag or spiral shape.

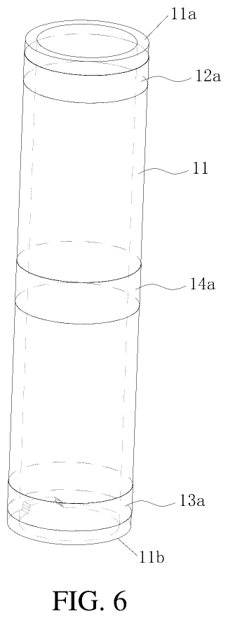

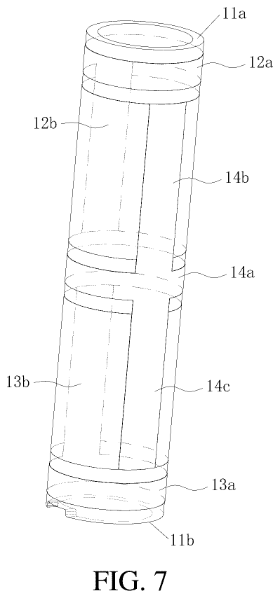

FIG. 6 shows another heater 10 according to an example of this application. The heater differs from the heater shown in FIG. 4 in that the conductive element further includes a third electrode 14a. The first electrode 12a, the third electrode 14a, and the second electrode 13a are arranged sequentially in an axial direction. For a shape, a material, and the like of the third electrode 14a, refer to the first electrode 12a or the second electrode 13a and the foregoing content. The first electrode 12a, the third electrode 14a, and the second electrode 13a separate the infrared electric heating coating into two infrared electric heating coatings in an axial direction. Each infrared electric heating coating can independently receive the power supplied by the cell 30 to generate heat, so as to generate an infrared ray, which is radiated to heat different parts of the aerosol-forming substrate.

FIG. 7 shows another heater 10 according to an example of this application. The heater differs from the heater shown in FIG. 6 in that the conductive element further includes a conductive portion 12b extending axially from the first electrode 12a toward the third electrode 14a, a conductive portion 13b extending axially from the second electrode 13a toward the third electrode 14a, a conductive portion 14b extending axially from the third electrode 14a toward the first electrode 12a, and a conductive portion 14c extending axially from the third electrode 14a toward the second electrode 13a. The conductive portion 14b is axially aligned with the conductive portion 14c, i.e., the two conductive portions are on a same longitudinal line. The first electrode 12a, the third electrode 14a, and the second electrode 13a separate the infrared electric heating coating into two infrared electric heating coatings in an axial direction, the conductive portion 12b and the conductive portion 14b separate an upper infrared electric heating coatings into two infrared electric heating coatings in the circumferential direction, and the conductive portion 13b and the conductive portion 14c separate a lower infrared electric heating coating into two infrared electric heating coatings in the circumferential direction. Each of the two infrared electric heating coatings separated in the axial direction can independently receive the power supplied by the cell 30 to generate heat, so as to generate an infrared ray, which is radiated to heat different parts of the aerosol-forming substrate.

Unlike the example in FIG. 7, in another example, the conductive element may include a plurality of conductive portions 12b, a plurality of conductive portions 13b, a plurality of conductive portions 14b, and a plurality of conductive portions 14c. The plurality of conductive portions 12b and the plurality of conductive portions 14b can separate the upper infrared electric heating coating into a plurality of infrared electric heating coatings in the circumferential direction, and the plurality of conductive portions 13b and the plurality of conductive portions 14c can separate the lower infrared electric heating coating into a plurality of infrared electric heating coatings in the circumferential direction.

Unlike the example in FIG. 7, in another example, the conductive portion 12b and the conductive portion 14b may not be arranged in the upper infrared electric heating coating. Alternatively, the conductive portion 13b and the conductive portion 14c may not be arranged in the lower infrared electric heating coating.

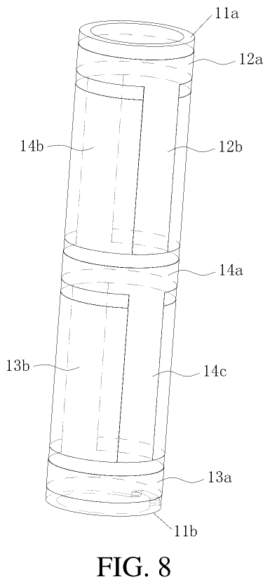

FIG. 8 shows still another heater 10 according to an example of this application. The heater differs from the heater shown in FIG. 7 in that the conductive portion 14b and the conductive portion 14c are in a staggered arrangement, i.e., the two conductive portions are not on a same longitudinal line.

It should be noted that, in the examples of FIG. 6 to FIG. 8, only two sections, namely, the upper section and the lower section are used as examples for illustration. It can be easily imagined that three or more sections are also feasible.

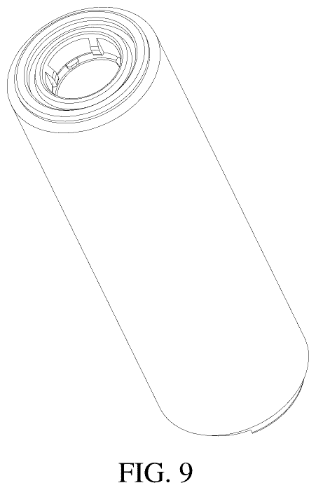

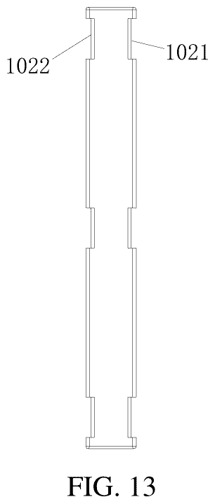

FIG. 9 to FIG. 15 show a heating assembly according to an example of this application. The heating assembly adopts the heater shown in FIG. 6. It can be easily imagined that the heating assembly may adopt any of the heaters shown in FIG. 4 to FIG. 5 and FIG. 7 to FIG. 8 after being simply changed.

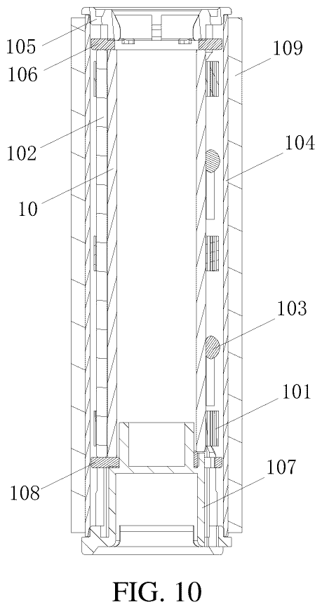

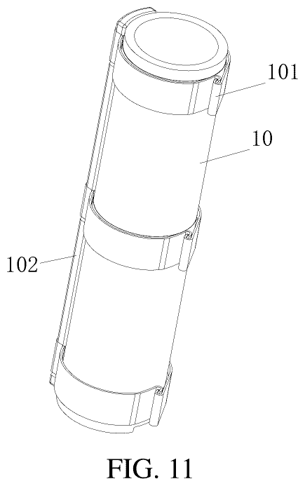

As shown in FIG. 9 to FIG. 10, the heating assembly includes a heater 10, an electrode connecting member 101, a fixing member 102, a temperature sensor 103, a heat insulation tube 104, an upper end cap 105, a seal member 106, a lower end cap 107, a seal member 108, and a heat insulation member 109.

For the heater 10, refer to FIG. 6 and the foregoing description, and details are not described herein.

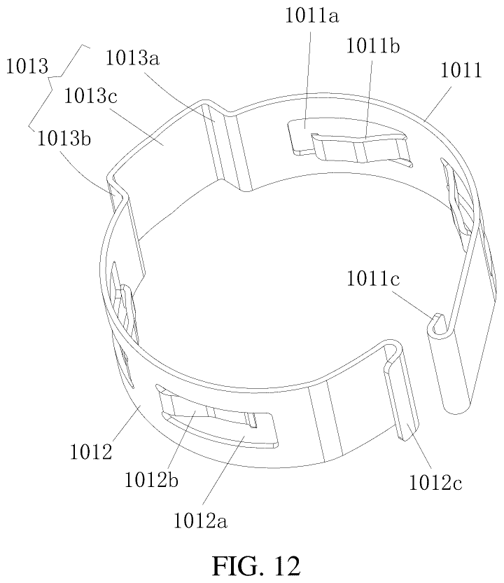

As shown in FIG. 11 to FIG. 12, the electrode connecting member 101 is overall substantially in a C shape. The electrode connecting member 101 includes a contact piece 1011, a contact piece 1012, and a separator 1013. The electrode connecting member 101 is preferably made of a copper alloy material, such as beryllium copper, titanium copper, or phosphor copper. A surface of the electrode connecting member 101 may be plated with gold, silver, or tin, to reduce a contact resistance and improve a service life of electrode connecting member 101.

The contact piece 1011 is provided with a through hole 1011a and a cantilever 1011b. One end of the cantilever 1011b is fixed to an inner wall of the through hole 1011a (i.e., formed on the contact piece 1011 by hollowing), and another end thereof extends toward inside of the electrode connecting member 101 and is suspended. Alternatively, one end of the cantilever 1011b may not be fixed to the inner wall of the through hole 1011a, for example, may be fixed to outside of the through hole 1011a. When the cantilever abuts against the electrode on the base body 11, an elastic force can be generated, to achieve an electrical connection with the electrode. Numbers of through holes 1011a and cantilevers 1011b are not defined. Preferably, a plurality of through holes 1011a and a plurality of cantilevers 1011b are arranged. Similarly, the contact piece 1012 is provided with a through hole 1012a and a cantilever 1012b.

It should be noted that, the manner of achieving the electrical connection between the contact piece 1011 or the contact piece 1012 and the electrode is not limited to the cantilever shown in the examples of FIG. 11 to FIG. 12. In another example, a protruding portion may be arranged on the contact piece 1011 or the contact piece 1012, to maintain contact with the electrode, thereby forming an electrical connection. Alternatively, in another example, an electrical connection may be formed by maintaining an inner wall of the contact piece 1011 or the contact piece 1012 in contact with the electrode without arranging a cantilever.

The contact piece 1011 and the contact piece 1012 are both substantially in an arc shape, which matches a shape of the outer surface of the base body 11. One end (or a connecting end) of the contact piece 1011 is integrally formed with the separator 1013. An other end (or a free end) of the contact piece 1011 is provided with a first connecting portion 1011c. Similarly, one end (or a connecting end) of the contact piece 1012 is integrally formed with the separator 1013, and another end (or a free end) of the contact piece 1012 is provided with a second connecting portion 1012c separated from the first connecting portion 1011c. The other end of the contact piece 1011 and the other end of the contact piece 1012 may be detachably connected through the first connecting portion 1011c and the second connecting portion 1012c.

It should be noted that, in another example, the electrode connecting member 101 may not be provided with the separator 1013, and one end of the contact piece 1011 may be directly integrally formed with one end of the contact piece 1012.

The specific implementations of the first connecting portion 1011c and the second connecting portion 1012c are not defined.

In the examples of FIG. 11 to FIG. 12, the other end of the contact piece 1011 is bent to form a locking hook, and the other end of the contact piece 1012 is also bent to form a locking hook, but the two are bent in opposite directions. To be specific, the other end of the contact piece 1011 is bent toward the inside of the electrode connecting member 101, and the other end of the contact piece 1012 is bent toward outside of the electrode connecting member 101. In this way, after being engaged with each other, the first connecting portion 1011c and the second connecting portion 1012c can be locked together, i.e., are not easily detached from each other in a circumferential direction, thereby connecting the electrode connecting member 101 in an annular shape as a whole. When the first connecting portion 1011c and the second connecting portion 1012c need to be detached from each other, the first connecting portion and the second connecting portion may be unbuckled, so that the other end of the contact piece 1011 can be separated from the other end of the contact piece 1012.

In another example, locking may be achieved by mating between a locking hook and a locking hole, or by mating between a locking hook and a protruding limiting block, or by mating between a latch with a hole and a bump.

In another example, the bent portion of the other end of the contact piece 1011 and the bent portion of the other end of the contact piece 1012 may abut closely against each other and then be fixed with a fastener such as a screw.

It can be easily imagined that, the other end of the contact piece 1011 may alternatively be provided with the second connecting portion, and the other end of the contact piece 1012 may alternatively be provided with the first connecting portion.

The separator 1013 includes a clamping portion 1013a, a clamping portion 1013b, and an abutting portion 1013c. The clamping portion 1013a and the clamping portion 1013b both extend radially toward the outside of the electrode connecting member 101, and the abutting portion 1013c extends circumferentially and matches an outer surface of the fixing member 102. One end of the abutting portion 1013c is integrally formed with one end of the contact piece 1011 through the clamping portion 1013a, and another end thereof is integrally formed with one end of the contact piece 1012 through the clamping portion 1013b. The abutting portion 1013c is substantially spaced apart from the base body 11. A lead electrically connected to the electrode connecting member 101 may be welded on an outer surface of the abutting portion 1013c. In this way, the lead can be prevented from falling off due to an excessively high welding spot temperature.

Through mating between the fixing member 102 and the separator 1013, the electrode connecting member 101 is prevented from moving in an axial direction of the base body 11. The fixing member 102 is preferably made of a high temperature-resistant and insulative material, such as a PBI, PI, or PEEK material.

Specifically, the fixing member 102 is substantially in a strip shape, and an inner surface (a surface facing the base body 11) is an arcuate surface, which matches the shape of the outer surface of the base body 11. The fixing member 102 is further provided with a positioning groove 1021 and a positioning groove 1022 mated with the separator 1013.

After the fixing member 102 is fitted to the separator 1013 (or the electrode connecting member 101), the clamping portion 1013a is mated with the positioning groove 1021, the clamping portion 1013b is mated with the positioning groove 1022, the abutting portion 1013c abuts against the outer surface of the fixing member 102, and the inner surface of the fixing member 102 abuts against the outer surface of the base body 11, i.e., the fixing member 102 is held between the separator 1013 and the base body 11. An axial length of the positioning groove 1021 (or a height of the positioning groove 1021) is slightly greater than an axial length of the clamping portion 1013a, and an axial length of the positioning groove 1022 is slightly greater than an axial length of the clamping portion 1013b, to prevent axial movement of the electrode connecting member 101 after the fitting. A distance (a horizontal distance or a circumferential distance) between the clamping portion 1013a and the clamping portion 1013b is slightly less than a distance between the positioning groove 1021 and the positioning groove 1022, to clamp the fixing member 102 after the fitting. An axial length of the fixing member 102 is substantially the same as an axial length of the base body 11. The lead electrically connected to the electrode connecting member 101 may be arranged along the outer surface of the fixing member 102, to avoid an excessively high temperature of the lead.

In the example of FIG. 11, three electrode connecting members 101 are used to form electrical connections with the electrodes of the heater 10 (the first electrode 12a, the second electrode 13a, and the third electrode 14a) in one-to-one correspondence. Correspondingly, the fixing member 102 is provided with three sets of positioning grooves 1021 and positioning grooves 1022. In this way, the three electrode connecting members 101 are tightly fixed to the base body 11 through the fixing member 102.

The temperature sensor 103 is configured to sense temperature information of the heater 10. In the examples of FIG. 9 to FIG. 15, two temperature sensors 103 are arranged, with one temperature sensor 103 being in contact with the upper infrared electric heating coating and the other temperature sensor 103 being in contact with the lower infrared electric heating coating. The two temperature sensors 103 sense the temperature information of the infrared electric heating coatings in one-to-one correspondence, which facilitates temperature control of the heater 10.

The upper end cap 105 is arranged on a first end 11a of the base body 11, and the seal member 106 is arranged between the upper end cap 105 and the first end 11a. The lower end cap 107 is arranged on a second end 11b of the base body 11, and the seal member 108 is arranged between the lower end cap 107 and the second end 11b. The heat insulation tube 104 is arranged on the outside of the base body 11 in an axial direction of the chamber, and the heat insulation member 109 is sleeved outside the heat insulation tube 104.

The heat insulation tube 104 is in a tubular shape, with an upper end abutting against the upper end cap 105 and a lower end abutting against the lower end cap 107. A specific gap is maintained between an inner wall of the heat insulation tube 104 and the heater 10, and the seal member 106 and the seal member 108 abut against the inner wall of the heat insulation tube 104. In this way, the gap between the inner wall of the heat insulation tube 104 and the heater 10 is substantially sealed to reduce or block eat transfer in the radial direction more effectively. The heat insulation tube 104 may be made of a plastic material such as PI, PEEK, or high temperature-resistant PC, the seal member 106 and the seal member 108 are made of a silica gel material, and the heat insulation member 109 may be made of an aerogel material.

The upper end cap 105 and the lower end cap 107 are both made of an electrically insulative, high temperature-resistant, and thermally insulative material.

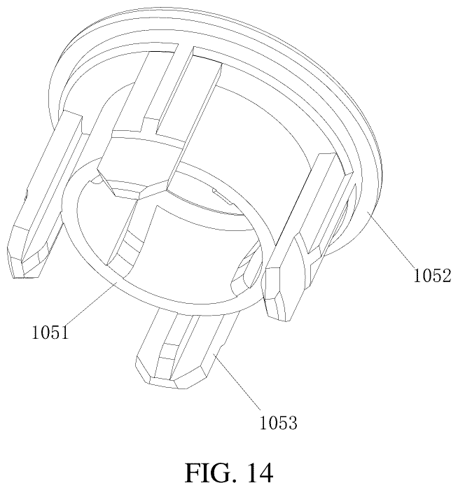

As shown in FIG. 14, the upper end cap 105 includes a hollow tube 1051, a protruding portion 1052 extending from an end of the hollow tube 1051 in the radial direction of the chamber, and a holding portion 1053 extending from an axial direction of the protruding portion 1052. When the upper end cap 105 is arranged on the first end 11a of the base body 11, the holding portion 1053 abuts against the outer surface of the base body 11 to hold the first end 11a of the base body 11. An upper end portion of the heat insulation tube 104 may abut against the protruding portion 1052. Two opposite surfaces of the holding portion 1053 in the radial direction each have a bump (not shown) extending radially. When the upper end cap 105 is arranged on the first end 11a of the base body 11, the bump on one of the surfaces abuts against the outer surface of the base body 11. When the upper end portion of the heat insulation tube 104 abuts against the protruding portion 1052, the bump on the other of the surfaces abuts against an inner surface of the heat insulation tube 104.

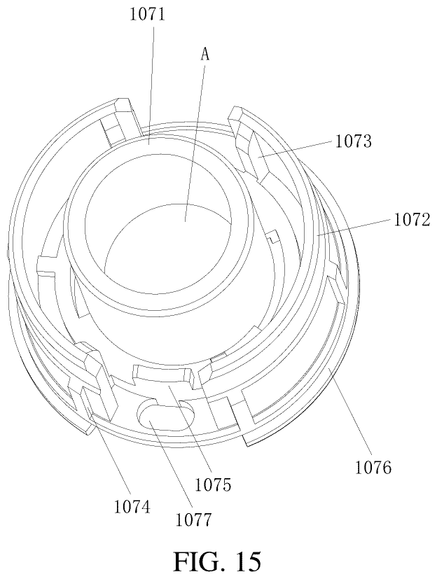

As shown in FIG. 15, the lower end cap 107 includes an inner cylinder 1071 and an outer cylinder 1072, and the second end 11b of the base body 11 is arranged between an outer wall of the inner cylinder 1071 and an inner wall of the outer cylinder 1072.

The inner cylinder 1071 has a closed end and an opposite open end. When the aerosol-generating article 200 is received in the chamber 20, the aerosol-generating article 200 abuts against the open end of the inner cylinder 1071, so that a closed chamber A is formed between the closed end and the open end. The closed chamber A may store an aerosol generated by heating, so that a smoke concentration can be increased during inhalation by a user, thereby improving inhalation experience of the user. In addition, the closed chamber A may collect condensates and residues to facilitate cleaning of the aerosol-generating apparatus. During the inhalation by the user, external air may flow to a bottom end of the aerosol-generating article 200 along a gap between the aerosol-generating article 200 and an inner surface of the base body 11, thereby forming an airflow flowing path.

The outer wall of the outer cylinder 1072 includes a plurality of abutting portions 1074 distributed circumferentially and extending toward the heat insulation tube 104, and an end portion of the outer cylinder 1072 has a protruding portion 1076 extending in the radial direction of the chamber. The abutting portions 1074 and the protruding portion 1076 are arranged to facilitate fitting to the heat insulation tube 104, so that the lower end portion of the heat insulation tube 104 can abut against the protruding portion 1076. The inner wall of the outer cylinder 1072 includes a plurality of holding portions 1073 arranged at intervals. The holding portions 1073 extend from the inner wall of the outer cylinder 1072 toward the inner cylinder 1071. When the base body 11 is arranged on the lower end cap 107, the holding portions 1073 abut against the outer surface of the base body 11 to hold the second end 11b of the base body 11. The lower end cap 107 is further provided with a circumferential stop portion configured to prevent the base body 11 from rotating. The circumferential stop portion includes a positioning protrusion 1075 protruding toward a side of the base body 11 at the lower end cap 107. An end wall of the second end portion 11b of the base body 11 is provided with a positioning notch correspondingly mated with the positioning protrusion 1075. When the base body 11 is arranged on the lower end cap 107, the positioning protrusion 1075 is correspondingly mated with the positioning notch, to prevent the base body 11 from rotating circumferentially relative to the lower end cap 107. The lower end cap 107 is further provided with a via 1077 for a lead (a lead of the temperature sensor 103 or the lead electrically connected to the electrode connecting member 101) to extend through.

It should be noted that, the specification of this application and the drawings thereof provide preferred embodiments of this application. However, this application may be implemented in various different forms, and is not limited to the embodiments described in this specification. These embodiments are not used as an additional limitation on the content of this application, and are described for providing a more thorough and comprehensive understanding of the content disclosed in this application. Moreover, various embodiments not listed above formed by further combining the foregoing technical features with each other are all construed as falling within the scope of this application. Further, a person of ordinary skill in the art may make improvements or modifications according to the foregoing descriptions, and all of the improvements and modifications shall fall within the protection scope of the appended claims of this application.

1. A heating assembly comprising:
a heater configured to heat an aerosol-forming substrate to generate an aerosol, wherein the heater is provided with an electrode; and
an electrode connecting member comprising a first contact piece and a second contact piece, wherein at least one of the first contact piece and the second contact piece maintains contact with the electrode to form an electrical connection;
wherein:
the first contact piece is provided with a first connecting portion;
the second contact piece is provided with a second connecting portion that is separated from the first connecting portion; and
the first connecting portion and the second connecting portion are configured to be integrated together to hold the electrode connecting member on the heater.

2. The heating assembly according to claim 1, wherein:
one end of the first contact piece is integrally formed with one end of the second contact piece; and
another end of the first contact piece is separated from another end of the second contact piece.

3. The heating assembly according to claim 2, wherein:
the first connecting portion comprises a first locking hook formed by bending the other end of the first contact piece toward inside of the electrode connecting member; and
the second connecting portion comprises a second locking hook formed by bending the other end of the second contact piece toward outside of the electrode connecting member.

4. The heating assembly according to claim 1, wherein:
the first contact piece comprises a first cantilever formed on the first contact piece by hollowing, and the first cantilever is configured to maintain contact with the electrode to form an electrical connection.

5. The heating assembly according to claim 1, wherein:
the electrode connecting member further comprises a separator arranged between the first contact piece and the second contact piece; and
the separator is at least partially spaced apart from the heater.

6. The heating assembly according to claim 5, wherein:
the heating assembly further comprises a fixing member; and
the fixing member is held between the separator and the heater.

7. The heating assembly according to claim 6, wherein:
the separator comprises an abutting portion spaced apart from the heater; and
the fixing member is held between the abutting portion and the heater.

8. The heating assembly according to claim 7, wherein:
the separator comprises a clamping portion arranged between one end of the abutting portion and one end of the first contact piece or between another end of the abutting portion and an end of the second contact piece; and
the fixing member comprises a positioning groove, and the clamping portion is held in the positioning groove.

9. The heating assembly according to claim 8, wherein an axial length of the positioning groove is greater than an axial length of the clamping portion.

10. The heating assembly according to claim 8, wherein:
the separator comprises a first clamping portion arranged between one end of the abutting portion and one end of the first contact piece and a second clamping portion arranged between another end of the abutting portion and one end of the second contact piece;
the fixing member comprises a first positioning groove configured to hold the first clamping portion and a second positioning groove configured to hold the second clamping portion; and
a distance between the first positioning groove and the second positioning groove is greater than a distance between the first clamping portion and the second clamping portion.

11. The heating assembly according to claim 6, wherein:
the heater comprises a plurality of electrodes and a plurality of electrode connecting members;
the plurality of electrodes are arranged sequentially in an axial direction of the heater; the plurality of electrode connecting members form electrical connections with the plurality of electrodes in one-to-one correspondence; and
the fixing member is held between the separator of each of the plurality of electrode connecting members and the heater.

12. The heating assembly according to claim 5, wherein:
the heating assembly further comprises a lead electrically connected to the electrode connecting member; and
the lead is welded on a surface of a part of the separator spaced apart from the heater.

13. The heating assembly according to claim 1, wherein the heater comprises:
a base body, having an outer surface; and
an electric heating coating, formed on the outer surface of the base body,
wherein:
the electrode comprises a first electrode, a second electrode, and a third electrode, the electrode further comprises a first conductive portion extending from the third electrode toward the first electrode and a second conductive portion extending from the third electrode toward the second electrode; the first conductive portion and the second conductive portion are in a staggered arrangement; and
a first electric heating coating is arranged between the third electrode and the first electrode, a second electric heating coating is arranged between the third electrode and the second electrode, and the first electric heating coating and the second electric heating coating are configured to be independently started.

14. An aerosol-generating apparatus comprising a power supply assembly and the heating assembly according to claim 1.

15. The heating assembly according to claim 1, wherein the second contact piece comprises a second cantilever formed on the second contact piece by hollowing, and the second cantilever is configured to maintain contact with the electrode to form an electrical connection.

16. The heating assembly according to claim 4, wherein the second contact piece comprises a second cantilever formed on the second contact piece by hollowing, and the second cantilever is configured to maintain contact with the electrode to form an electrical connection.
